(19) United States
(12) Patent Application Publication
(10) Pub. No.: US 2021/0100343 A1
(43) Pub. Date: Apr. 8, 2021

(54) HINGED CONNECTION APPARATUS

(71) Applicant: Johnny Rhymes with Connie, LLC, Roseville, MN (US)

(72) Inventor: John A. Murphy, Roseville, MN (US)

(21) Appl. No.: 17/039,438

(22) Filed: Sep. 30, 2020

Related U.S. Application Data
(60) Provisional application No. 62/910,668, filed on Oct. 4, 2019.

(51) Int. Cl. A45F 5/02; F16M 13/00

(52) U.S. Cl. CPC A45F 5/022; A45F 2005/002; F16M 13/005

(57) ABSTRACT

A hinged support apparatus for a portable electronic display device is disclosed that includes a mounting plate having a first and a second end portion. The mounting plate comprises an opening or mortise into which a magnetically susceptible material, such as a metallic plate, can be embedded. The disclosed hinged support apparatus also includes an elongated base having a proximal end and a distal end in which the proximal end is attached to the first end portion of the mounting plate. The elongated base can include at least one living hinge and, in some embodiments, one or more magnets. The magnets can be made of any ferromagnetic material. The disclosed hinged support apparatus can include an elastic band having a first end and a second end. The first end of the elastic band can be attached to the first end of the base, and the second end of the elastic band can be attached to the second end of the base.

### RELATED APPLICATIONS

This application claims the benefit of U.S. Provisional Patent Application Ser. No. 62/910,668, filed Oct. 4, 2019, entitled “HINGED SUPPORT APPARATUS”, currently pending, which is herein incorporated by reference in its entirety.

### FIELD

This disclosure relates to hinged supports for small, portable electronic display devices that can withstand repeated flexing without breaking and are useful for holding the electronic displays at viewable angles.

### BACKGROUND

Portable electronic display devices such as, for example, cell phones, tablets, and other small electronic displays having a visible display, are almost universally used in today's world. Most of these devices have a planar viewing display and may be hard to view—especially by a user sitting at a desk, in a chair, or viewing the display at an angle for one reason or another.

Stands are available for such devices into which the electronic display can be attached or inserted. Then the stands can be set upright on a surface such as a desk or table and can allow the display face of the electronic display to be viewed at an angle that is easily seen by a user. These stands can be freestanding and can sometimes have collapsible legs or stands to hold them upright.

### SUMMARY

The currently available stands for portable electronic display devices are somewhat bulky and typically larger than the electronic display itself enabling the electronic display to be inserted into the stand for upright use. What would be useful would be a small, portable apparatus that could directly attach to a small portable electronic display, such as a cell phone, that would allow it to be held at a viewable angle for users.

In one aspect, a hinged support apparatus for a portable electronic display device is disclosed that includes a mounting plate having a first and a second end portion. The mounting plate comprises an opening or mortise into which magnetic material, such as a metallic plate, can be embedded. The disclosed hinged support apparatus also includes an elongated base having a proximal end and a distal end in which the proximal end is attached to the first end portion of the mounting plate. In some embodiments, the elongated base can be aligned with a substantial portion of the mounting plate when collapsed. The elongated base can include at least one living hinge and, in some embodiments, one or more magnets. The magnets can be made of any ferromagnetic material. Typically, strong magnets that include neodymium can be used in the disclosed apparatus. The disclosed hinged support apparatus can include an elastic band having a first end and a second end. The first end of the elastic band can be attached to the first end of the base, and the second end of the elastic band can be attached to the second end of the base.

In another aspect, an article is disclosed that can include a portable electronic display and a hinged support apparatus for a portable electronic display. The hinged support apparatus for a portable electronic display can include a mounting plate having a first and a second end portion. The mounting plate can comprise ferromagnetic material. The disclosed hinged support apparatus can also include an elongated base having a first end (proximal end) and a second end (distal end) in which the first end is attached to the first end portion of the mounting plate. In some embodiments, the base can be aligned with a substantial portion of the mounting plate when collapsed. The base can include at least one living hinge and the base can include one or more magnets. The disclosed hinged support apparatus can include an elastic band having a first end and a second end. The first end of the elastic band can be attached to the first end of the base and the second end of the elastic band can be attached to the second end of the base.

In yet another aspect, a method of using a hinged support apparatus for a portable electronic display is disclosed that can include an apparatus for a portable electronic display device such as that described above. The method can further include attaching the hinged support apparatus to the mounting plate. Additionally, the method also can include stretching the elastic band to separate the elongated base from the mounting plate to form a self-standing easel comprising the portable electronic display.

In this application, the terms:

“aligned” refers to two elongated parts being substantially oriented along the same axis;

“living hinge” refers to a thin hinge made from the same material as the two rigid pieces it connects. It is typically thinned or cut to allow the rigid pieces to bend along the line of the hinge;

“mortise” refers to a recess cut into a part that allows another part to fit completely within the recess;

“mounting plate” refers to a part of the disclosed apparatus that is anchored to a portable electronic display device and forms the foundation of the disclosed hinged support apparatus;

“strong adhesive” refers to an adhesive that can hold substantial weight tightly and, in some embodiments can be a curable adhesive or an adhesive designed for structural use; and

“substantially coplanar” refers to two planar objects that are oriented in parallel planes or are oriented in very close to parallel planes. In this application, they are oriented within five degrees of each other.

The disclosed hinged support apparatus described herein provides a small, portable apparatus that is easily applied by a user of a portable display device. This apparatus can be used as a stand for the portable display device to allow the display device to be held at a comfortable viewing angle by the user. The apparatus is easily applied by the user, collapses to a substantially planar configuration or can be converted to an easel configuration in which the apparatus acts as an “easel-like” stand for the display device.

### BRIEF DESCRIPTION OF THE DRAWINGS

The following description should be read with reference to the drawings. The drawings, which are not necessarily to scale, depict examples and are not intended to limit the scope of the disclosure. The disclosure may be more completely understood in consideration of the following description with respect to various examples in support with the accompanying drawings, in which:

FIG. 1 is a perspective view of an embodiment of a disclosed hinged support apparatus in an easel configuration.

FIG. 2A is a perspective view of an embodiment of a disclosed hinged support apparatus in a collapsed configuration.

FIG. 2B is a top down planar view of the embodiment of the disclosed hinged support apparatus shown in FIG. 2A.

FIG. 2C is a side view of the embodiment of the disclosed hinged support apparatus shown in FIG. 2A.

FIG. 3A is a top down perspective view of the elongated base portion of the hinged support apparatus illustrated in FIG. 1A.

FIG. 3B is a top down planar view of the elongated base portion illustrated in FIG. 3A.

FIG. 3C is a bottom up planar view of the elongated base portion illustrated in FIG. 3A.

FIG. 4A is a side view of an embodiment of the disclosed article illustrated in FIG. 1A that includes an attached portable electronic display device and is in an easel configuration.

FIG. 4B is a perspective view of an embodiment of the disclosed article illustrated in FIG. 1A that includes an attached portable electronic display device and is in an easel configuration.

FIG. 5 shows an embodiment of a disclosed article used as a clip to hold a portable electronic display device in a pocket.

FIG. 6 shows an embodiment of a disclosed article used for storage of earphones.

### DETAILED DESCRIPTION

In the following description, reference is made to the accompanying set of drawings that form a part of the description hereof and in which are shown by way of illustration several specific embodiments. It is to be understood that other embodiments are contemplated and may be made without departing from the scope or sprit of the present disclosure. The following detailed description, therefore, is not to be taken in a limiting sense. Unless otherwise indicated, all members expressing sizes, amounts, and physical properties used in the specification and claims are to be understood as being modified in all instances by the term “about.” Accordingly, unless indicated to the contrary, the numerical parameters set forth in the foregoing application and attached claims are approximations that can vary depending upon the desired properties sought to be obtained by those skilled in the art utilizing the teachings disclosed herein. The use of numerical ranges by endpoints includes all members within that range (e.g., 1 to 5 includes 1, 1.5, 2, 2.75, 3, 3.80, 4, and 5) and any range within that range.

The present disclosure relates to a hinged support apparatus useful for portable electronic displays such as, but not limited to, cell phones, smart tablets, portable radios, small computers, controllers, and other handheld electronic displays. The disclosed hinged support apparatus can exist in a number of different configurations. In one configuration, the disclosed support apparatus can be collapsed so that all of its components (mounting plate, elongated base, and elastic band) can be substantially coplanar. In another configuration (herein referred to as an “easel configuration”), the proximal end portion of the elongated base can be essentially coplanar with the mounting plate (usually adhered to an electronic display device), but the elongated base can be bent at one or two or more? living hinges to splay out at an angle from the mounting plate (easel configuration) to form a supporting leg for the mounting plate and, if present, the portable electronic display device. In these easel configurations, the mounting plate can hold the portable electronic display device at an easily viewable angle of the user's choosing.

The disclosed hinged support apparatus can be used to form the back portion of an easel structure when the support is attached to the back of the electronic displays. In these configurations, which are described herein, the hinged support apparatus can self-support the electronic display and can hold it at a viewing angle desired by the user. It is contemplated that there are an infinite number of easel configurations depending upon the angle between the distal portion of the elongated base and the proximal end portion of the elongated base. However, to be useful, an easel configuration needs to hold the mounting plate (and attached portable electronic display device) at a comfortable viewing angle for the viewer and in a stable geometric configuration so that the easel does not fall or collapse.

The disclosed hinged support apparatus can include a mounting plate having a first and a second end portion. The mounting plate can be made of any rigid material and may include at least one opening through it. The mounting plate typically can be made of metal, ceramic, polymer, composite, or any rigid structural material. In some embodiments, the mounting plate can include an opening or mortise into which a strike plate can be inserted. The strike plate can be any material that can be attracted to a magnet. At least one surface of the mounting plate should be capable of adhering to a strong adhesive that can hold it tightly to the back of a portable electronic display. In some embodiments, the adhesive can be a curable adhesive such as an epoxy, melamine, polyurethane, cyanoacrylic, or other type of curable adhesive that results in a strong bond. In other embodiments the adhesive can be pressure-sensitive but have good holding power. Examples of strong pressure-sensitive adhesives include VHB tape, available from 3M, St. Paul, Minn.

The disclosed hinged support apparatus also can include an elongated base. The elongated base has a proximal end and a distal end. The proximal end of the elongated base can be attached to the first end or proximal end portion of the mounting plate. The elongated base can have one dimension that is substantially longer than the other dimension—in some embodiments the long dimension can be at least twice the length of the short diameter. In some embodiments the long dimension can be even longer than twice the length of the short diameter. When the disclosed hinged support is collapsed and the base can become substantially coplanar with the mounting plate, the elongated base can be substantially aligned and substantially overlaps with a substantial portion of the mounting plate.

The elongated base can be rigid enough to hold the weight of the electronic display when it is in an easel configuration but is capable of forming a living hinge. Typically, the elongated base can be made of high-density rubber, polypropylene, polyurethane, TEPG (polyethylene terephthalate glycol), TPU (thermoplastic polyurethane), or other rigid but not overly brittle plastics. The elongated base can include at least one living hinge across its short that extends approximately perpendicular to the long dimension of the base. The at least one living hinge can be located between the first, proximal, end portion and the second, distal, end portion of the elongated base allowing the elongated base to form the back side of an easel support for the electronic display. In some embodiments, the elongated base can include two or more living hinges. In most embodiments, the proximal end portion of the elongated base can be coplanar with the mounting plate and substantially coplanar with portable electronic display device.

The flat part of the elongated base between the proximal end of the base and the closest living hinge to the proximal end of the base, if there is more than one living hinge, can be attached to the first end portion of the mounting plate. Typically, the proximal end of the elongated base can include a magnet embedded within or inserted into a mortise of the elongated base. The magnet can hold the distal, flat, proximal, part of the elongated base flush to the back of the portable electronic display by being attracted to the strike plate embedded in the mounting plate. Similar to the proximal end of the elongated base, which can have a recess that permanently houses the mounting plate, the distal end of the elongated base can have a recess within it to accommodate the mounting plate when the easel form of the hinged support is collapsed and substantially coplanar. More specifically, the distal end of the elongated base can be flush or coplanar with the mounting plate when collapsed or can be splayed away from the mounting plate at an angle and form, in some embodiments, a support for the easel configuration of the disclosed hinged support. The one or more living hinges in the elongated base can allow for the distal end of the elongated base be self-standing and to form an acute angle with the mounting plate thereby holding the portable electronic display device at an angle of a viewer's choosing.

The disclosed hinged support can have an elastic band having a first end and a second end attached to the proximal end of the base and the end of the base distal from the side facing the mounting plate. The elastic band can be made of any stretchable or elastic material such as the material used in medical elastic wrap, material used in clothing, stretchable cloth, or any other material that can be stretched and is capable of returning its original dimensions. In particular, materials used in waistbands, for wristbands, SPANDEX, or for jewelry can work in this disclosure.

The elastic band can attach to both the distal end portion and the proximal end portion of the elongated base. In this configuration, the elastic band can act as a spring to hold the disclosed apparatus in an easel configuration. In the collapsed configuration the elastic band can be in a stretched mode. In this configuration, the magnet can hold the distal portion of the elongated base substantially coplanar with the strike plate (and the portable electronic display device). When the disclosed apparatus is moved to an easel configuration, the relaxation of the stretched elastic band can pull the distal portion of the elongated base away from the plane of the mounting plate forming a triangular base for upright positioning of the portable electronic display device.

Another feature of the elastic band can be to be used as a handle for the hinged support apparatus in a collapsed state to move it to an easel configuration. This can be done, for example, by inserting one or more fingers under the elastic band and pulling it in an outward direction. Similarly, the elastic band can be used to create a secure grip for users. For example, by inserting one or more fingers under the elastic band with the palm facing the portable electronic display device, a user can ensure the portable electronic display device will stay in his or her hands during use.

Some uses of the disclosed apparatus, particularly when it is attached to a portable electronic display device can be to form a clip to hold the portable electronic display device. For example, the disclosed apparatus can clip such a display device to an article of clothing, such as a pocket of a shirt, jacket, or pair of pants. In another embodiment, the disclosed apparatus can hold, for example, earphones when they are wrapped around the clip.

In another aspect, a method of using a hinged support apparatus for a portable electronic display device is disclosed that can include an apparatus for a portable electronic display such as that described above. The method further can include attaching the hinged support apparatus to the mounting plate using a strong adhesive. The method can also include pulling the elastic band to separate the magnet embedded in the elongated base from the portable electronic display device to form a self-standing easel comprising the portable electronic display.

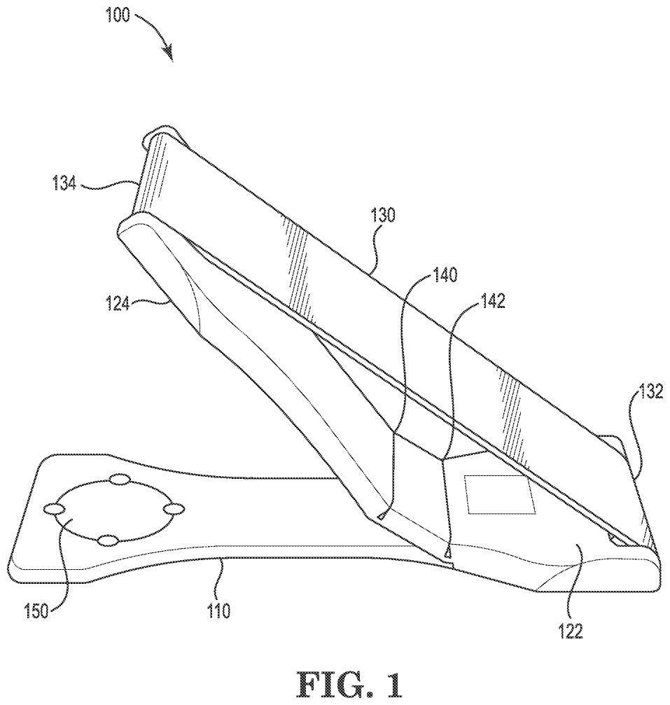

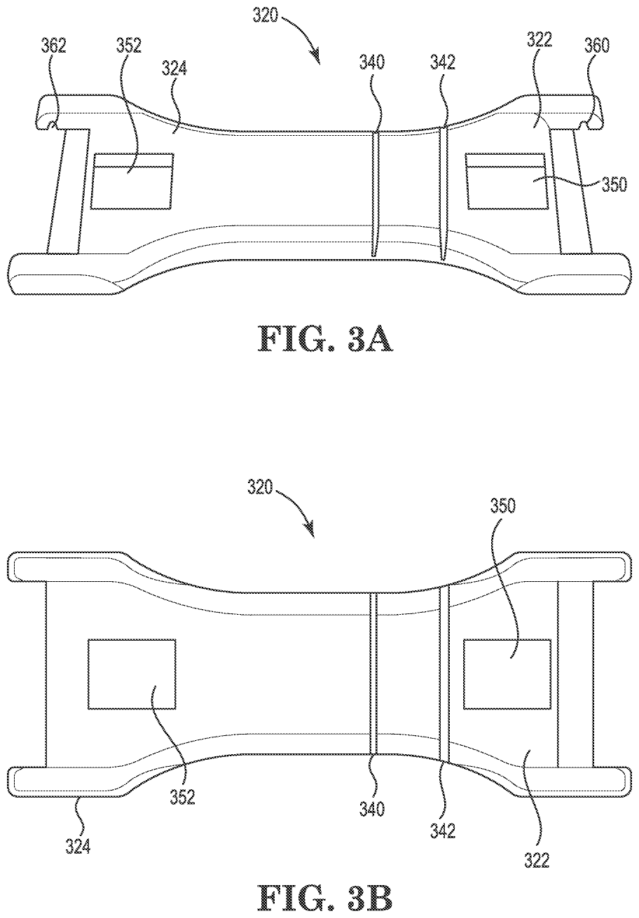

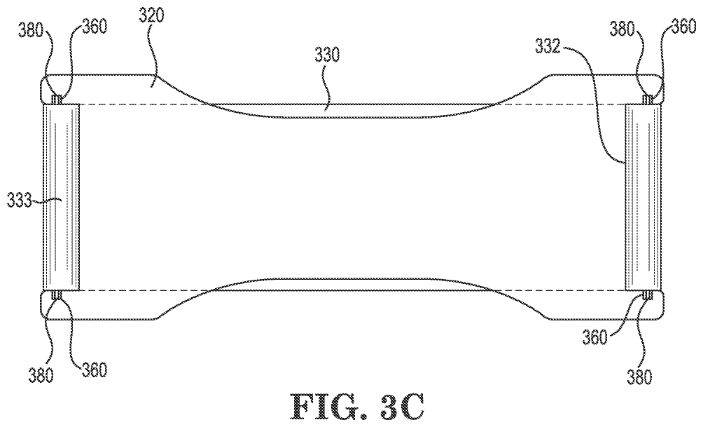

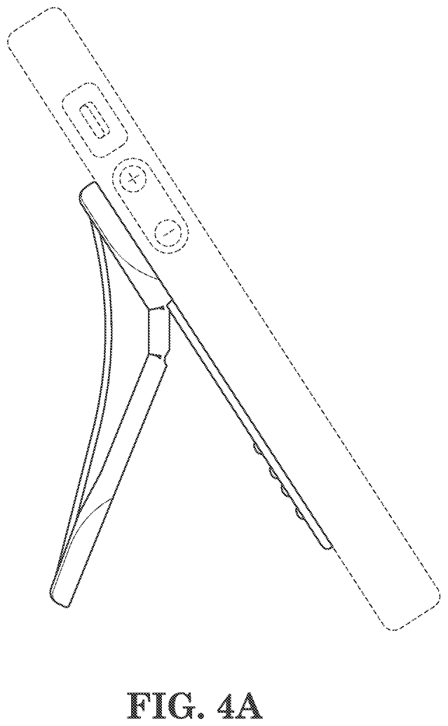

The disclosed device may be further understood by referring to the accompanying figures. FIG. 1 is a perspective view of an embodiment of a disclosed hinged support apparatus in an easel configuration. Apparatus 100 includes mounting plate 110. In some embodiments, mounting plate 110 can be attached to one side of a portable electronic display device. Typically, mounting plate 110 can be attached to the back side or back case of the portable electronic display device. Disposed upon and anchored to mounting plate 110 is proximal end portion 122 of elongated base. Mounting plate 110 can be anchored by any number of attachment methods such as the use of adhesives, welds, ultrasonic welds, screws, bolts, or other attachment methods known in the art. Proximal end portion 122 is substantially coplanar with mounting plate 110 and surrounds mounting plate 110 so that the edges of proximal end portion 122 are substantially flush with mounting plate 110. Distal end portion 124 of the elongated base can be splayed at an angle to proximal portion 122 of the elongated base. In the embodiment illustrated in FIG. 1, two living hinges 140 and 142 bend the intermediate portion of the elongated base that results in distal portion 124 residing at an angle with respect to proximal portion 122. The apparatus illustrated in FIG. 1 is in an easel configuration and can be self-standing. Elastic band 130 has first end 132 that attaches to proximal portion 122 of the elongated base and second end 134 attaches to distal portion 124 of the elongated base. The attachments are shown in more detail in FIG. 3C.

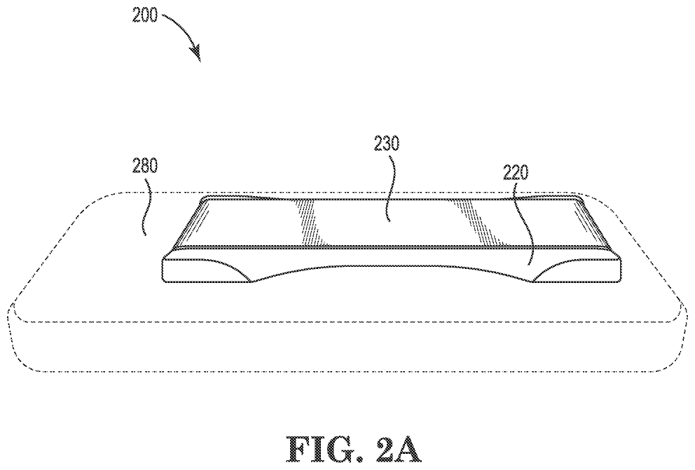

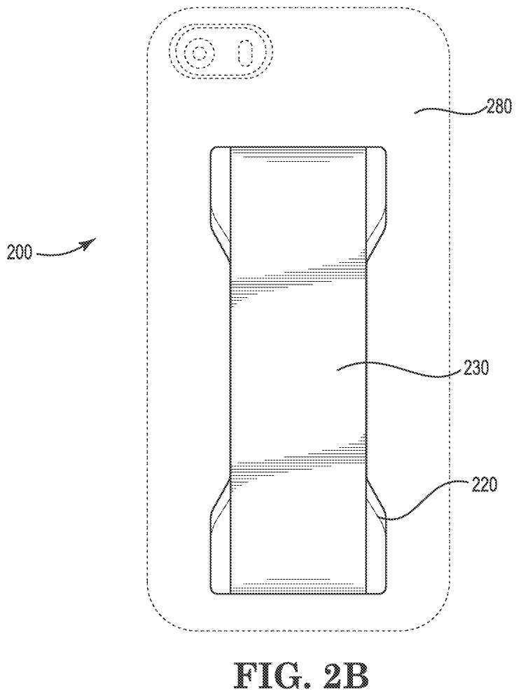

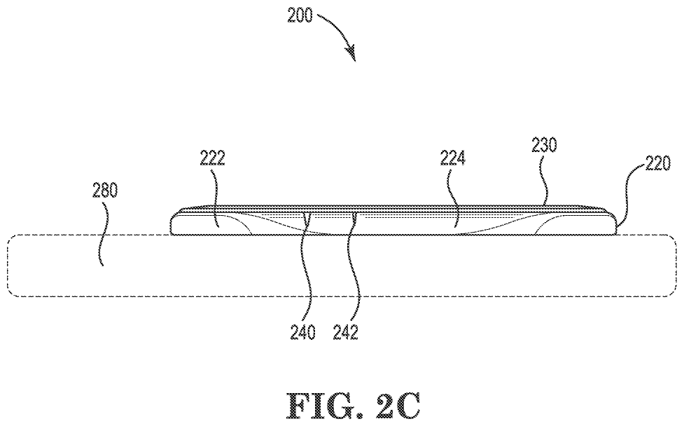

FIGS. 2A-C are perspective, top down planar, and side views, respectively, of an embodiment of a disclosed hinged support apparatus in a collapsed configuration. All reference numbers on FIGS. 2A-C refer to the same elements which are described herein. Hinged support apparatus 200 illustrated by the view shown in FIGS. 2A-C show apparatus 200 disposed upon the back of portable electronic display device 280 (not part of apparatus 200 and, in the embodiment shown in the Figures is a cell phone). The illustrations, collectively, show elongated base 220 disposed upon the backside of portable electronic device 280. Elongated base 220 covers over a mounting plate that is not visible in any of the Figures since elongated base 220 completely covers the mounting plate. In the side view, FIG. 2C, elongated base 220 includes two living hinges, 240 and 242 located between first, proximal end portion 222 and second, distal end portion 224 of elongated base 220. Although not shown in any of FIGS. 2A-C first, proximal end portion 222 of elongated base 220 is substantially coplanar with portable electronic display device 280 and remains so whether apparatus 200 is in its collapsed state (as shown in FIGS. 2A-C) or in an easel configuration as shown in accompanying figures.

FIGS. 3A and 3B are top down perspective and top down planar views, respectively, of elongated base portion 320 of the hinged support apparatus illustrated in FIG. 1A. Both FIGS. 3A and 3B illustrate proximal portion 322 of elongated base 320 and distal portion 324 of elongated base 320. In the illustrated embodiment, proximal portion 322 and distal portion 324 of elongated base 320 are separated by two living hinges 340 and 342. Also illustrated in this embodiment are two mortises or recesses 350 and 352, one mortise 350 embedded in proximal portion 322 and one mortise 352 embedded in distal portion 324 of elongated base 320. Magnets (not shown in the illustrations) can be fit into mortises 350 and 352. The magnets can be placed in the mortises so that they are within the mortises and do not project above the plane of the top (shown) substantially flat surface of elongated base 320. Also shown in FIG. 3A are notches 360 and 362 located at the tips of proximal and distal portions 322 and 324 of elongated base 320. These notches are useful for aiding in attachment of an elastic band (not shown in these figures) to the elongated base. One embodiment of attachment of the elastic band to the elongated base is shown in FIG. 3C.

FIG. 3C is a bottom up planar view of the elongated base portion illustrated in FIG. 3A. Elongated base 320 has elastic band 330 disposed upon its opposite side than that shown in the illustration. A portion of elastic band 330 is shown where not hidden by elongated base 320 due to the shape of elongated base 320 having a smaller diameter near its center compared to near proximal and distal portions 322 and 324. Also illustrated are the two ends 332 and 333 of elastic band 330 that are wrapped around spindles 380 as shown at each end of elongated base 320. In one embodiment, such as that illustrated in FIG. 3C, two spindles both labeled 380 can be, for example, a watch band pin. Spindles 380 can fit into notches both labeled 360 (and also shown in FIG. 3A) to hold elastic band. In some embodiments, the ends 332 and 333 are folded into a loop and secured so that spindles 380 can fit inside of the loop.

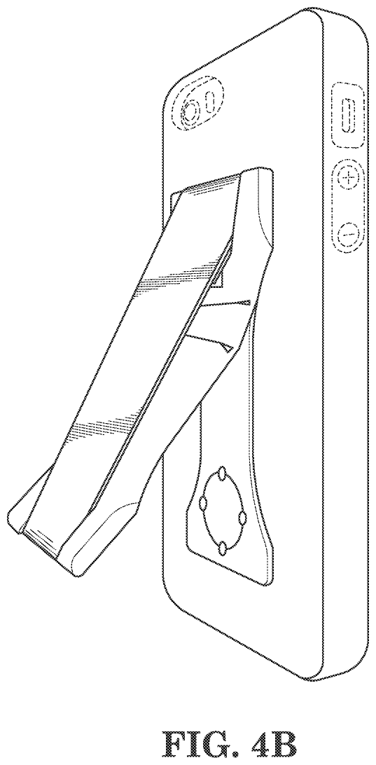

FIGS. 4A and 4B are a side views and perspective views, respectively, of an embodiment of the disclosed article that includes an attached portable electronic display device and is in an easel configuration.

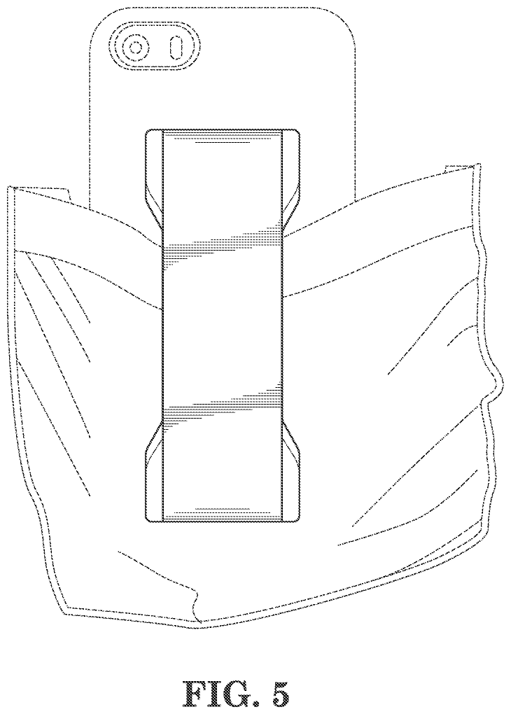

FIG. 5 shows an embodiment of a disclosed article used as a clip to hold a portable electronic display device in a pocket.

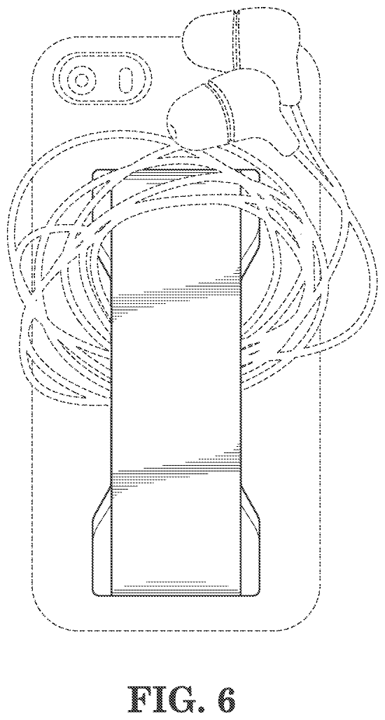

FIG. 6 shows an embodiment of a disclosed article used for storage of earphones.

Various modifications and alterations to this disclosure will become apparent to those skilled in the art without departing from the scope and spirit of this disclosure. It should be understood that this disclosure is not intended to be unduly limited by the illustrative embodiments set forth herein and that such embodiments are presented by way of example only with the scope of the disclosure intended to be limited only by the claims set forth herein as follows. All references cited in this disclosure are herein incorporated by reference in their entirety.

What is claimed is:

1. A hinged support apparatus for a portable electronic display comprising:
a mounting plate having a first and a second end portion;
an elongated base having a proximal end and a distal end, the proximal end attached to the first end portion of the mounting plate,
wherein the base is aligned with a substantial portion of the mounting plate when collapsed,
wherein the base comprises at least one living hinge, and
wherein the base comprises at least one magnet; and
an elastic band having a first end and a second end wherein the first end of the elastic band is attached to the proximal end of the base and the second end of the elastic band is attached to the distal end of the base.

2. A hinged support apparatus for a portable electronic display according to claim 1, wherein the mounting plate comprises a strong adhesive.

3. A hinged support apparatus for a portable electronic display according to claim 2, wherein the strong adhesive is attached to at least one side of the electronic display.

4. A hinged support apparatus for a portable electronic display according to claim 1, wherein the base comprises at least one living hinge.

5. A hinged support apparatus for a portable electronic display according to claim 4, wherein the base comprises two living hinges.

6. A hinged support apparatus for a portable electronic display according to claim 1, wherein the base comprises a magnet.

7. A hinged support apparatus for a portable electronic display according to claim 6, wherein the magnet comprises neodymium.

8. A hinged support apparatus for a portable electronic display according to claim 6, wherein the base comprises a mortise wherein the mortise comprises a magnet.

9. A hinged support apparatus for a portable electronic display according to claim 8, wherein the two magnets are magnetically oriented for symmetric attachment to the electronic display.

10. A hinged support apparatus for a portable electronic display according to claim 6, wherein the base comprises at least two magnets, one at the first end of the base and the other at the second end of the base.

11. A hinged support apparatus for a portable electronic display according to claim 1, wherein the mounting plate and the elongated base are substantially coplanar.

12. A hinged support apparatus for a portable electronic display according to claim 1, wherein at least a portion of the elongated base is not substantially coplanar and elongated base forms an easel with the mounting plate.

13. A hinged support apparatus for a portable electronic display according to claim 12, wherein the elongated base forms at least two planes neither of which is substantially coplanar with the mounting plate by bending at least one living hinge.

14. An article comprising:
a portable electronic display; and
a hinged support apparatus for a portable electronic display comprising:
a mounting plate having a first and a second end portion,
wherein the mounting plate comprises ferromagnetic material;
an elongated base having a proximal end and a distal end, the proximal end attached to the first end portion of the mounting plate,
wherein the base is aligned with a substantial portion of the mounting plate when collapsed,
wherein the base comprises at least one living hinge, and
wherein the base comprises a magnet; and
an elastic band having a first end and a second end wherein the first end of the elastic band is attached to the proximal end of the base and the second end of the elastic band is attached to the distal end of the base.

15. An article according to claim 14, wherein the mounting plate is attached to the portable electronic display, and
wherein the article forms an easel with one plane of the easel comprising the portable electronic display, and the other supporting plane of the easel comprising the elongated base, and
wherein the portable electronic display is not substantially coplanar with the elongated base.

16. An article according to claim 15, wherein the elongated base is bent so it lies in at least two different planes, neither of which is substantially coplanar with the portable electronic display.

17. A method of using a hinged support apparatus for a portable electronic display comprising:
providing an apparatus for a portable electronic display comprising:
a mounting plate having a first and a second end portion,
wherein the mounting plate comprises ferromagnetic material;
an elongated base having a proximal end and a distal end, the proximal end attached to the first end portion of the mounting plate,
wherein the elongated base is aligned with a substantial portion of the mounting plate when collapsed,
wherein the elongated base comprises at least one living hinge, and
wherein the elongated base comprises a magnet; and
an elastic band having a first end and a second end wherein the first end of the elastic band is attached to the proximal end of the elongated base and the second end of the elastic band is attached to the distal end of the base;
attaching the apparatus to the mounting plate using a strong adhesive; and
pulling the elastic band to separate the magnet embedded in the elongated base from the portable electronic display to form a self-standing easel comprising the portable electronic display.

18. A method according to claim 17, wherein the elongated base is bent at at least one of the living hinges to further stabilize the easel.

19. A method according to claim 18, wherein the elongated base is bent at at least the two living hinges to allow the electronic display to be positioned at an angle at which the display of the device is visible to a user at an oblique angle.
